(19) United States
(12) Patent Application Publication
(10) Pub. No.: US 2011/0253764 A1
(43) Pub. Date: Oct. 20, 2011

(54) PACKAGE FOR POINT HOOKS

(75) Inventor: JÜRGEN FABRICIUS, Paderborn (DE)

(73) Assignee: FABRICIUS FASTENER GMBH, Paderborn (DE)

(21) Appl. No.: 13/083,718

(22) Filed: Apr. 11, 2011

(30) Foreign Application Priority Data
Apr. 14, 2010 (EP) 10 159 869.6

(51) Int. Cl. B25C 5/16

(52) U.S. Cl. 227/120

(57) ABSTRACT

A package packages a variety of point hooks having angled tips, which are to be applied by a nailing machine. The point hooks are arranged side by side in a folded box, which on one of the narrow sides parallel to the point hooks has a slide opening, into which engages a slide of the nailing machine and pushes the point hooks across the box in such a way that respectively one hook is ejected on the opposite narrow side through an outlet into a strike position of the nailing machine.

### CROSS-REFERENCE TO RELATED APPLICATION

This application claims the priority, under 35 U.S.C. §119, of European application EP 10 159 869.6, filed Apr. 14, 2010; the prior application is herewith incorporated by reference in its entirety.

### BACKGROUND OF THE INVENTION

### Field of the Invention

The invention relates to a package for a variety of point hooks with an angled tip, which are to be applied by a nailing machine.

Pointed hooks are used for various purposes in construction, such as fixing slates on a supporting wooden structure on roofs or facades. Traditionally, the roofer carries slate hooks in a belt pouch and applies them one by one by hand with a hammer. This process is laborious and time-consuming, and if slate hooks fall they are often lost.

Point hooks are sold loose or they are joined by a flat adhesive tape.

Recently there is a growing trend towards the use of nail guns, in which a striker is moved abruptly, either electrically, hydraulically or pneumatically. They are used to drive fasteners, such as steel nails or screws, into a surface for fastening purposes. Typically, a plurality of fasteners is arranged on a flat narrow strip of cardboard or plastic fabric and fed to the device.

Published, European patent application EP 0 864 706 A1 describes a strip for slate roof hooks, which is suitable only for manually driving in the slate hooks. They are not intended for use with a nailing machine.

In Published, European patent application EP 0 915 4636, a magazine strip for slate hooks is described, which is configured as a plastic strip and can be used in a nailing machine. Before use, the magazine strip has to be loaded with the slate hooks in a laborious process, and it is only made for one kind of slate hook with an additional indent.

Also, the magazine strip is not suitable for storage and transport.

### SUMMARY OF THE INVENTION

It is accordingly an object of the invention to provide a package for point hooks which overcomes the above-mentioned disadvantages of the prior art devices of this general type, and which can also serve as a magazine for automated use and which is suitable for several types of point hooks.

With the foregoing and other objects in view there is provided, in accordance with the invention a package for a variety of point hooks having angled tips and to be applied by a nailing machine. The package contains a folded box for receiving the point hooks disposed side by side in the folded box. The folded box has narrow sides, and one of the narrow sides disposed parallel to the point hooks has a slide opening formed therein. A slide of the nailing machine engages in the slide opening and pushes the point hooks across the folded box such that respectively one point hook is ejected on an opposite one of the narrow sides having an outlet, and through the outlet, the one point hook is moved into a strike position of the nailing machine.

The package is configured for a variety of point hooks with an angled hook tip, which are to be applied by a nailing machine, also called a nailer. The point hooks are arranged side by side in a folded box which on one of the narrow sides parallel to the point hooks has a slide opening. A slide of the nailing machine engages in the slide opening in such a way that it pushes the point hooks across the box in such a way that respectively one hook is ejected on the opposite narrow side through an outlet into a strike position of the nailing machine.

Because of the configuration of the package as a folding box with a sliding opening and an outlet for the hooks that are arranged in parallel, this package not only serves as a transport and storage package, but also as a magazine for the automated use of the point hooks by a nailing machine. A slide in a magazine carrier of the nailing machine transports the point hooks to the strike position and a striker then drives the point hook into its designated position.

The point hook can have a number of different shapes. It may be straight or have indents. Its end can be straight as well, or curved. The proposed package is suitable for such variants.

For storage and transportation of point hooks, the outlet opening of the package is provided with a removable closure. This can simply be an adhesive tape.

Other features which are considered as characteristic for the invention are set forth in the appended claims.

Although the invention is illustrated and described herein as embodied in a package for point hooks, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

BRIEF DESCRIPTION OF THE SEVERAL VIEWS OF THE DRAWING

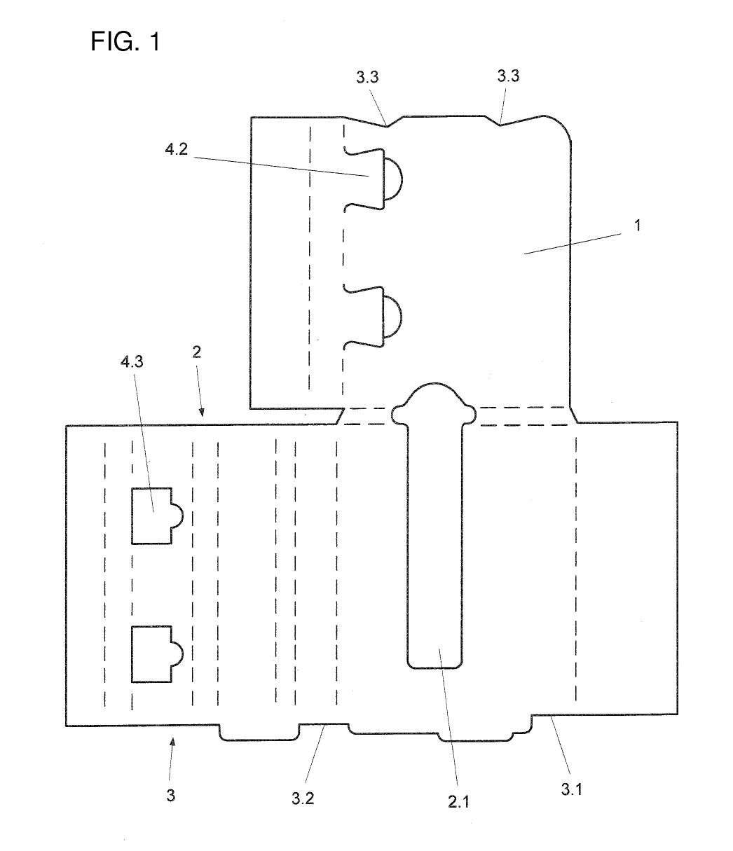

FIG. 1 is a diagrammatic, plan view of a blank of a package according to the invention;

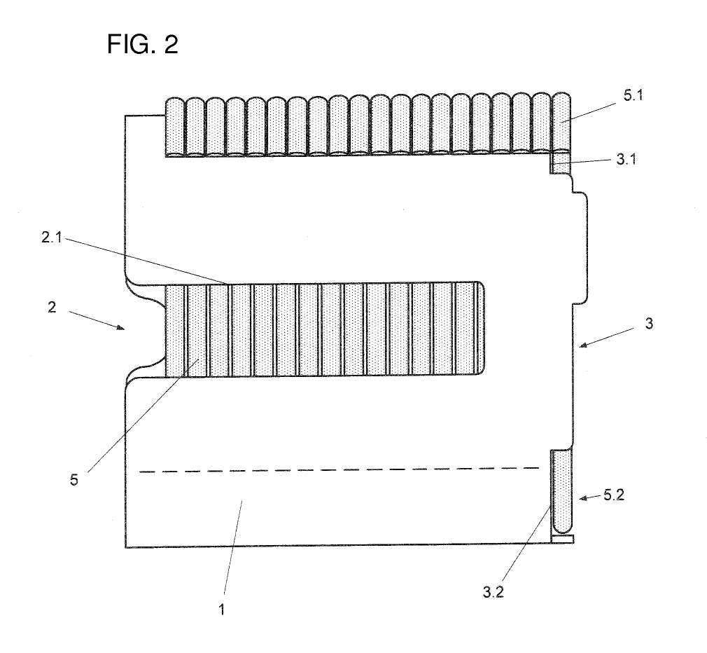

FIG. 2 is a diagrammatic, plan view of a filled folded box;

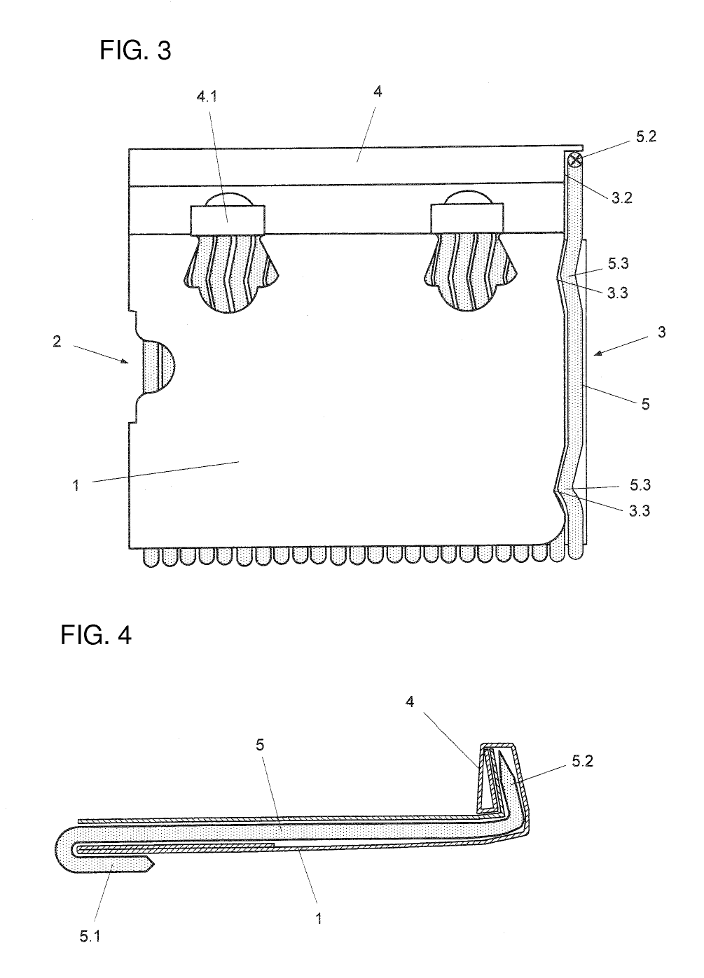

FIG. 3 is a diagrammatic, bottom view of the filled folded box;

FIG. 4 is a diagrammatic, sectional view of the filled folded box; and

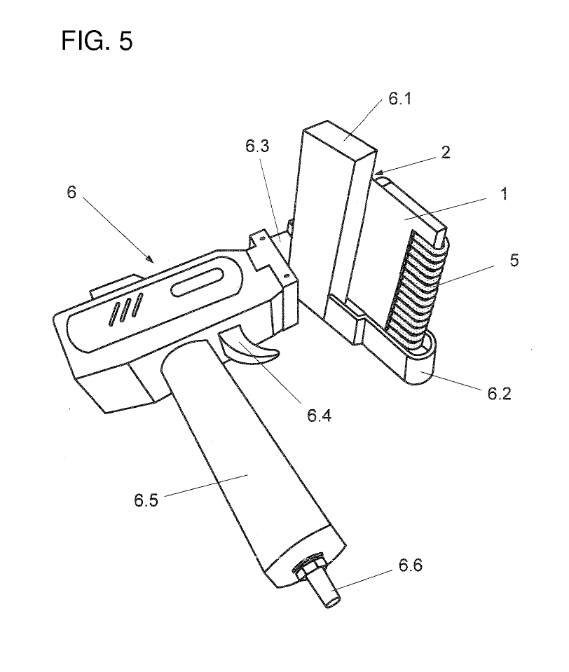

FIG. 5 is a diagrammatic, perspective view of a nailing machine with the package as a magazine.

### DETAILED DESCRIPTION OF THE INVENTION

Referring now to the figures of the drawing in detail and first, particularly, to FIG. 1 thereof, there is shown a blank of a folding box 1 in a plan view. Perforated lines are punched on the blank, defining the folding of the box.

Approximately in the center of the blanks a sliding opening 2 is obtained by folding and a glide opening 2.1 for the slide of the nailing machine is punched out. Furthermore, tabs 4.2 and openings 4.3 are punched, for the purpose of locking the box.

A recess 3.1 for the curved end of the point hook and a recess 3.2 for the striker, are cut out on the side of the blank forming the outlet opening 3. The notches for point hooks with indents are provided at the opposite end of the blank.

FIGS. 2 and 3 each show a side view of opposite sides of the folded box 1, which is filled with point hooks 5.

Curved ends 5.1 of the point hooks 5 project from the folded box 1 and extend around an edge of the folded box 1. A point hook 5 is located at the outlet opening 3 in the strike position, as its pointed tip 5.2 in the recess 3.2 is accessible to a striker, and its curved end 5.1 is exposed by the recess 3.1.

FIG. 3 shows the notches 3.3 at the outlet opening 3, which are intended for point hooks 5 with indents 5.3. Furthermore, the raised part 4 of the folded box 1 is indicated, as well as its locking mechanism 4.1 with openings and tabs.

On the side of the slide opening 2, a slide of the nailing machine can push the hooks 5 further across the box. The glide opening 2.1 is open for the slide.

FIG. 4 shows a cross section through the folded box 1 with a point hook 5. Its pointed tip 5.2 is protected in the raised part 4. A curved end 5.1 of the point hook 5 projects from the folded box 1 and around its edge.

FIG. 5 shows a nailing machine 6 with a magazine carrier 6.1 attached to its striker guide 6.3, in which the slide (not visible) is guided. The folded box 1 filled with point hooks 5 is held in the bracket 6.2, and a point hook 5 is placed in the strike position by the slide in the sliding door 2. The process of driving in the hook is actuated by the trigger 6.4.

The connection 6.6 is shown on the handle 6.5. The nailing machine 6 can be operated either electrically or pneumatically.

1. A package for a variety of point hooks having angled tips and to be applied by a nailing machine, the package comprising:
a folded box for receiving the point hooks disposed side by side in said folded box, said folded box having narrow sides, one of said narrow sides disposed parallel to the point hooks having a slide opening formed therein and a slide of the nailing machine engaging in said slide opening and pushing the point hooks across said folded box such that respectively one point hook is ejected on an opposite one of said narrow sides having an outlet, and through said outlet, the one point hook is moved into a strike position of the nailing machine.

2. The package according to claim 1, wherein said folded box has a removable closure covering said outlet during storage and transport.

3. The package according to claim 1, wherein said folded box has a raised folded part for protecting pointed tips of the point hooks.

4. The package according to claim 1, wherein said narrow side opposite pointed tips of the point hooks remains open for the point hooks having curved ends.

5. The package according to claim 1, wherein said folded box has a glide opening formed therein for the slide of the nailing machine and is formed in a top of said folded box opposite pointed tips of the point hook.

6. The package according to claim 1, wherein said outlet has a recess formed therein at a top of said folded box for a striker of the nailing machine.

7. The package according to claim 4, wherein said outlet has a recess formed therein at a top of said folded box for receiving the curved ends of the point hooks.

8. The package according to claim 1, wherein said folded box has notches for accommodating indents of the point hooks and said notches are disposed at said outlet at a top of said folded box.

9. The package according to claim 1, wherein said folded box is made as a one piece unit.

10. The package according to claim 9, wherein said folded box is cut out of cardboard.

11. The package according to claim 10, wherein said folded box has tabs and openings formed therein receiving said tabs for locking said folding box.
